(19) United States
(12) Patent Application Publication
(10) Pub. No.: US 2026/0142797 A1
(43) Pub. Date: May 21, 2026

(54) MICRO-ARCHITECTURE FOR MATRIX-BASED (NON-SUBSTITUTION-PERMUTATION NETWORK) CRYPTOGRAPHY

(71) Applicant: IPK Technologies Inc., Del Mar, CA (US)

(72) Inventors: William F. Van Duyne, San Diego, CA (US); Gwain Bayley, Portland, OR (US); William Spazante, San Diego, CA (US); Bruce Robert Meagher, San Diego, CA (US)

(73) Assignee: IPK Technologies Inc., Del Mar, CA (US)

(21) Appl. No.: 19/377,663

(22) Filed: Nov. 3, 2025

Related U.S. Application Data
(60) Provisional application No. 63/722,787, filed on Nov. 20, 2024.
(60) Provisional application No. 63/778,882, filed on Mar. 27, 2025.

(51) Int. Cl. H04L 9/06

(52) U.S. Cl. CPC H04L 9/0618

(57) ABSTRACT

A hardware-accelerated micro-architecture for encryption systems such as but not limited to McEliece that do not rely on substitution-permutation networks. The invention comprises dedicated hardware blocks for linear transformations (including matrix multiply and accumulate), arithmetic and logic operations, and data obfuscation through scrambling and permutation, all coordinated by a central sequencer. Input data is selectively routed through configurable data paths to undergo a sequence of matrix operations, such as multiplication with dynamically generated or stored matrix keys, to produce encrypted output. The micro-architecture is highly adaptable and may be deployed as integrated cores within any conventional processor (including GPUs, NPUs, CPUs, and DSPs), as standalone accelerators in FPGAs or ASICs, or as chiplets in multi-chip modules and chip-stacking configurations. By leveraging existing matrix operation hardware originally designed for graphics or AI, or through custom silicon, the invention delivers high-performance, energy-efficient McEliece encryption and decryption without the latency and overhead of substitution-permutation ciphers. The system supports both symmetric and asymmetric modes of McEliece, key encapsulation, authorization, and authentication, with dynamically configurable parameters for enhanced security. This approach enables efficient, scalable, and future-proof cryptographic acceleration tailored for matrix-based non-SPN encryption, particularly the McEliece framework, across communication, storage, and computing platforms.

### CROSS-REFERENCE TO RELATED APPLICATIONS

This application claims the benefit of priority under 35 U.S.C. § 119(e) to U.S. Provisional Patent Application No. 63/722,787, entitled “Systems and Methods for Matrix Based Security,” filed on Nov. 20, 2024, and U.S. Provisional Patent Application No. 63/778,882, entitled “Systems and Methods for Matrix Based Security,” filed on Mar. 27, 2025. The disclosures of each of these provisional applications are hereby incorporated by reference in their entirety.

### BACKGROUND OF THE INVENTION

### 1. Field of Invention

The present invention relates to network security and, more particularly, hardware architectures designed to enhance digital security against evolving cyber threats.

### 2. Description of Related Art

As digital information becomes central to the operations of businesses, governments, and individuals, safeguarding sensitive data against increasingly sophisticated cyber threats is a persistent and urgent technical challenge. Security-critical applications require encryption systems that are not only highly robust against attacks but also efficient enough to keep pace with rapidly expanding data volumes and stringent latency requirements.

Historically, the security industry has recognized that software-based encryption methods often impose significant processing overhead, throttling system performance and increasing energy consumption, particularly as data volumes rise. To mitigate these burdens, research and development efforts have been directed toward the hardware acceleration of encryption systems through the use of dedicated hardware components to perform specific computational tasks much faster and more efficiently than would be possible using general-purpose software running on a conventional processor. For example, cryptographic accelerators (sometimes called crypto accelerators) are specialized chips or hardware extensions such as processor instruction sets that perform encryption and decryption operations far more efficiently than a central processing unit (CPU) could in software alone. This approach is especially important for servers, network devices, and embedded systems where encryption/decryption is a major part of the workload.

Hardware acceleration efforts in cryptography have focused on supporting block ciphers that rely on substitution-permutation network (SPN) operations, such as advanced encryption standard (AES) algorithms. The SPN framework processes plaintext through alternating rounds of substitution and permutation operations; substitution via S-boxes, which introduce non-linearity and confusion, and permutation via P-boxes, which introduce diffusion by reordering bits. SPN-based ciphers like AES have dominated secure communications and storage, so chip manufacturers and hardware designers have optimized cryptographic accelerators specifically for these types of algorithms. As a result, cryptographic accelerators today are built to process these SPN workloads.

However, many modern cryptographic algorithms do not rely on a substitution-permutation network structure, which are referred to herein as non-SPN ciphers or algorithms. For example, McEliece is a code-based public-key cryptosystem, first introduced by Robert McEliece in 1978. Unlike AES, which relies on repeated S-box and P-box operations, McEliece uses a one-time scramble and permutation via matrix operations. Although it was not originally designed with quantum computers in mind, McEliece is now considered a candidate for post-quantum cryptography because no efficient quantum algorithm is known to break it. The McEliece cryptosystem, originally based on asymmetric cryptography, has been modified to use symmetric-key encryption concepts.

There is a notable lack of dedicated hardware acceleration for these non-SPN ciphers, even though they offer unique security properties such as being candidates for post-quantum cryptography. The absence of hardware acceleration for non-SPN ciphers has created a gap: while SPN encryption and decryption can be extremely fast in hardware, non-SPN ciphers like McEliece have remained in software, limiting their practical performance and adoption.

This shortfall is particularly concerning as attackers develop more advanced methods for circumventing traditional encryption, and as the need for efficient, strong, and flexible security solutions intensifies across computing, communications, storage, and emerging artificial intelligence domains. There is thus a pressing need for new hardware architectures capable of accelerating non-SPN encryption schemes, providing both the computational efficiency and the strengthened security posture required to address current and future data protection challenges. In the future, as the demand for post-quantum and other advanced cryptographic schemes grows, the availability of dedicated hardware for non-SPN ciphers will become increasingly important.

### SUMMARY OF THE INVENTION

The present invention addresses this need by introducing hardware acceleration for non-SPN, matrix-based ciphers such as but not limited to McEliece. A matrix hardware engine for security (“MHE-S”) micro-architecture is provided to accelerate cryptographic schemes grounded in matrix operations, representing a distinct departure from the traditional hardware approach that accelerates AES's substitution-permutation network of transformations. The micro-architecture is engineered to execute matrix-based cryptography, for example, McEliece encryption, by carrying out sophisticated linear, arithmetic, logical, and scrambling transformations directly in hardware. This enables true hardware acceleration for non-SPN cryptosystems, improving the speed and efficiency of both encryption and decryption. The MHE-S micro-architecture is flexible enough to support both symmetric and asymmetric non-SPN ciphers, as well as custom hybrid approaches and can be adapted for next-generation cryptographic workloads.

In some embodiments, the MHE-S micro-architecture is implemented either as a dedicated, self-contained module or as a hybrid system combining hardware, software, and firmware. The micro-architecture is designed for flexibility, enabling its integration directly into existing processor chips or as an independent component, depending on application requirements. The MHE-S micro-architecture can be implemented in existing processors such as graphics processing units (GPUs) with or without artificial intelligence (AI) functions and digital signal processors (DSP), neural processing units (NPUs), and CPUs with AI functions. The present invention demonstrates how to repurpose the matrix multiply and accumulate functions of the existing processors to act as a matrix-based non-SPN hardware accelerator. By repurposing these compute elements, whose matrix hardware was not originally designed for security operations, the disclosed micro-architecture delivers efficient, matrix-based encryption acceleration without dependence on traditional SPN structures. This inventive use of general-purpose and AI-optimized processor hardware opens new pathways for high-performance cryptographic acceleration in a broad range of computing platforms. Furthermore, the present invention is capable of operating in direct conjunction with ongoing data processing tasks, allowing security functions to be tightly coupled with graphics processing, artificial intelligence workloads, or any form of general computation. This integration enables strong and adaptable data protection across communications networks, storage environments, and AI-driven applications.

In an embodiment of the invention, a system for matrix-based non-substitution and permutation network (non-SPN) encryption or decryption hardware acceleration comprises a matrix operations block configured to perform, in hardware, multiply/accumulate or multiply and addition, as part of matrix-based non-SPN encryption or decryption of data. The matrix operations block may comprise a linear transformations block configured to perform a linear transformation selected from the group consisting of: multiply, multiply/accumulate, addition, change of basis, inner (dot) product, quantization, scaling, rotations, shearing, and a combination thereof. The matrix operations block may comprise an arithmetic and logic unit (ALU) block configured to perform an operation selected from the group consisting of: Boolean operation, addition, bit or byte manipulation, and a combination thereof. The matrix operations block is also configured to perform, in hardware, multiply/accumulate or multiply and addition, as part of graphics processing or artificial intelligence processing. The matrix operations block may comprise a scramble/permutation block configured to perform bit, multi-bit, or muti-byte changes defined by a scramble table and/or perform bit, multi-bit, or muti-byte shuffling as defined by a permutation table. The system may further comprise a memory block storing data selected from the group consisting of: one or more keys used in the matrix-based non-SPN encryption or decryption of data, one or more scramble tables, one or more permutation tables, and a combination thereof. The system may further comprise a pseudo-random number generator block to generate one or more keys used in the matrix-based non-SPN encryption or decryption of data. The system may further comprise a sequencer block configured to control data flow and an order of matrix operations. The matrix-based non-SPN encryption or decryption of data may be based on a McEliece cryptosystem, and the matrix operations block may be configured to perform at least one each of matrix operations: a scramble, an error correction code (ECC) encode, and a permutation. The matrix operations block may be implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller. The system may be assisted by one or more processor instructions. The matrix-based non-SPN encryption or decryption of data may comprise asymmetric encryption, symmetric encryption, or key encapsulation. The matrix-based non-SPN encryption or decryption of data may also enable authorization or authentication.

In another embodiment of the invention, a method for matrix-based non-substitution and permutation network (non-SPN) encryption or decryption hardware acceleration, comprises performing, within a matrix operations block, multiply/accumulate or multiply and addition in hardware, as part of matrix-based non-SPN encryption or decryption; and outputting encrypted or decrypted data. The matrix operations block may comprise a linear transformations block, and the method may perform, within the linear transformations block, a linear transformation selected from the group consisting of: multiply, multiply/accumulate, addition, change of basis, inner (dot) product, quantization, scaling, rotations, shearing, and a combination thereof. The matrix operations block may comprise an arithmetic and logic unit (ALU) block, and the method may perform, within the ALU block, an operation selected from the group consisting of: Boolean operation, addition, bit or byte manipulation, and a combination thereof. The method may further comprise performing, within the matrix operations block, multiply/accumulate or multiply and addition in hardware, as part of graphics processing or artificial intelligence processing. The matrix operations block may comprise a scramble/permutation block, and the method may perform, within the scramble/permutation block, bit, multi-bit, or muti-byte changes defined by a scramble table, and/or bit, multi-bit, or muti-byte shuffling as defined by a permutation table. The method may comprise storing, in a memory block, data selected from the group consisting of: one or more keys used in the matrix-based non-SPN encryption or decryption of data, one or more scramble tables, one or more permutation tables, and a combination thereof. The method may comprise generating, using a pseudo-random generator block, one or more keys used in the matrix-based non-SPN encryption or decryption of data. The method may comprise controlling, using a sequencer block, data flow and an order of matrix operations. The matrix-based non-SPN encryption or decryption of data may be based on a McEliece cryptosystem, and the method may perform, within the matrix operations block, at least one each of matrix operations: a scramble, an error correction code (ECC) encode, and a permutation. The matrix operations block may be implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller. The method may comprise processing one or more processor instructions as part of the matrix-based non-SPN encryption or decryption of data. The matrix-based non-SPN encryption or decryption of data may comprise asymmetric encryption, symmetric encryption, or key encapsulation. The matrix-based non-SPN encryption or decryption of data may enable authorization or authentication.

The present invention offers several substantial advantages that address critical limitations in both current cryptographic systems and hardware architectures for data security. By specifically targeting non-SPN ciphers such as McEliece, the invention provides hardware acceleration for encryption algorithms that are not optimally served by traditional hardware accelerators. This approach yields dramatic improvements in encryption and decryption speed, energy efficiency, and computational scalability, all while maintaining or improving the strength of data obfuscation and security. Its modular micro-architecture, based on a suite of dedicated matrix operations such as parallel matrix multiplication, accumulation, logic, arithmetic, and scrambling can be embedded directly within a wide variety of processors, including GPUs, NPUs, CPUs, DSPs, or even realized as standalone chips. This flexibility enables seamless integration into both legacy and next generation computing environments, permitting cryptographic acceleration to occur alongside, and even within, standard data processing, graphics, or artificial intelligence workloads.

The invention is designed for both symmetric and asymmetric cryptographic modes and can support advanced functions like key encapsulation, authentication, and dynamic protocol adaptation, making it highly adaptable for evolving security requirements, including those posed by quantum threats. The architecture's replicable and scalable nature allows for parallelization, redundancy, and specialized deployments across communications, storage, and embedded systems including environments where performance or low latency is paramount. The architecture's use of large matrices, dynamic keys, and error correction makes brute force, side-channel, and timing attacks far more difficult, if not impossible. By filling a previously unmet need for high-performance hardware acceleration of non-SPN security methods, the invention positions itself as a foundational building block for robust, energy-efficient, and future-proof data protection in modern digital systems.

The preceding paragraphs have been provided as a general introduction and are not intended to limit the scope of the following claims. The described embodiments and further advantages will be best understood by reference to the following detailed description in conjunction with the accompanying drawings.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a matrix hardware engine for security (MHE-S) micro-architecture 100 according to an embodiment of the invention.

FIG. 2A and FIG. 2B illustrate encryption/encode and decryption/decode flows for symmetric McEliece encryption using MHE-S.

FIG. 3 illustrates a processor system incorporating one or more MHE-S cores according to an embodiment of the invention.

FIG. 4 illustrates an Intelligent PolyKey (IPK) frame structure according to an embodiment of the invention.

FIG. 5 presents a functional categorization of the MHE-S micro-architecture's blocks, as introduced in FIG. 1.

### DETAILED DESCRIPTION OF PREFERRED EMBODIMENTS

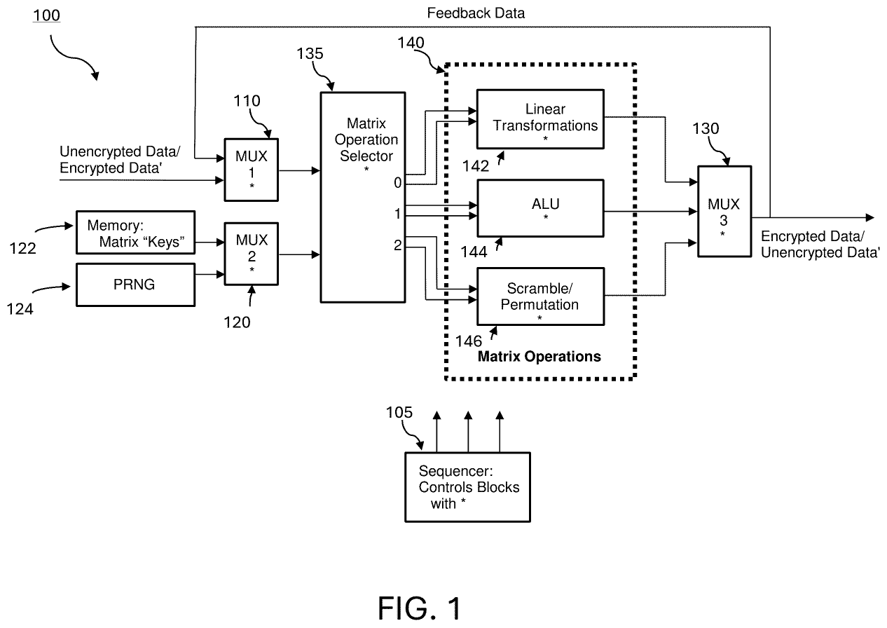

Aspects of the present invention are best understood by reference to the detailed description set forth herein and accompanying FIGS. 1-5. However, it should be understood that the following description, while indicating preferred embodiments and numerous specific details, is given by illustration only and should not be considered limiting. Changes and modifications may be made without departing from the spirit and scope thereof, and the present invention herein includes all such modifications.

The present invention is a matrix hardware engine for security (MHE-S) that accelerates non-SPN encryption relative to software non-SPN encryption implementations. MHE-S performs matrix operations (MOs) to obfuscate data in dedicated or programmable hardware. The MOs include but are not limited to linear transformations, logical operations, arithmetic operations, bits or byte shift or reversal, and scramble/permutation functions. The linear transformations may include multiply, multiply/accumulate, addition, change of basis, inner product, quantization, scaling, rotations, and shearing. In some embodiments, the encryption techniques may use error correction codes. In some embodiments, the encryption may use integer or real matrices that may be orthogonal or complex matrices that may be unitary. The MHE-S's micro-architecture applies to all communication and non-communication environments, including but not limited to all wired and wireless communications, data center, and storage at any open systems interconnection (OSI) layer.

The focus of the novel hardware micro-architecture described herein is matrix-based non-SPN ciphers. Because SPNs use a series of substitution (S-Boxes) and permutation (P-Boxes) layers to encrypt data, there is significant processing overhead due to multiple feedback iterations, or rounds. Non-SPN ciphers do not require substitution or permutation feedback iterations. As an example of an SPN cipher, AES is always a symmetric cipher; a common secret key is used between sender and receiver. As an example of a non-SPN cipher, McEliece may function as an asymmetric or symmetric cipher, either a public/private key (asymmetric) or a common secret key (symmetric) is used between sender and receiver. When comparing the software implementations of AES and McEliece, the AES cipher will take significantly longer to encrypt or decrypt data than the McEliece cipher due to the multiple rounds required for the substitution-permutation network. Hardware acceleration of SPN ciphers, and specifically AES, are more competitive with the software implementations of non-SPN ciphers. However, the hardware acceleration of non-SPN ciphers provides performance, efficiency, and energy benefits over not only non-SPN encryption via software but both SPN encryption in software and hardware. As used herein, the term “McEliece cryptosystem” refers to any cryptosystem based on McEliece, whether symmetric or asymmetric, and includes all variants of McEliece, whether currently known or developed in the future.

FIG. 1 illustrates an MHE-S micro-architecture core 100 according to an embodiment of the invention, which may be implemented in any chip. The MHE-S micro-architecture 100 comprises several modular components, or blocks, each interconnected to enable accelerated, flexible, and secure matrix-based cryptographic processing. Unencrypted Data may be input to the MHE-S and by the application of a series of matrix operations, the encoded output is Encrypted Data. Also, Encrypted Data′ may be input to the MHE-S and by the application of a series of matrix operations that undo the encoded matrix operations, the decoded output is Unencrypted Data′.

As used herein, the term “block” refers to a modular hardware component, or a combination of hardware and/or software including software alone, that is functionally grouped to perform one or more specific tasks within the larger system. The blocks are configured to interact with other blocks or components via well-defined interfaces to perform the overall functions of the system. The system may be implemented as a self-contained or centralized system, or a distributed system where one or more blocks are located on different networked components. The term “block” may also indicate one or more functions.

A sequencer block 105 acts as a scheduling mechanism for the core 100 with specific control over multiplexers MUX1 110, MUX2 120, and MUX3 130, matrix operation selector 135 and matrix operations block 140. The multiplexors, MUX1 110, MUX2 120, and MUX3 130 allow for the proper data path selection as controlled by the sequencer block 105. MUX1 110 either selects Unencrypted Data/Encrypted Data′ as per the sequencer block 105.

The matrix operations block 140 comprises three sub-blocks: a linear transformations 142, an arithmetic and logic unit (ALU) 144, and a scramble/permutation 146. The chosen matrix operation(s) is(are) set by the sequencer block 105. The linear transformations block 142 performs a variety of matrix-based linear transformations including but not limited to multiply, multiply/accumulate, addition, change of basis, inner (dot) product, quantization, scaling, rotations, and shearing. The sub-blocks 142, 144, and 146, including any subsets and portions thereof, may be implemented in hardware, software, or a combination of hardware and software. In an embodiment of the invention, at least the multiply/accumulate operation (a single, combined operation) or the multiply and the addition operations (two separate steps), are implemented in hardware to accelerate a non-SPN cryptosystem.

The ALU block 144 implements Boolean operations, addition, and bit/byte manipulations, e.g., shifting and reversal. Some non-SPN ciphers may require a cycle redundancy check (CRC) or hash function. The CRC or hash may be implemented using the ALU 144, dedicated hardware, or software. The scramble/permutation block 146 allows bit value changes as defined by a scramble table and bit shuffling as defined by a permutation table. In certain embodiments, the scramble and permutation functions within the system can be expanded to operate on multi-bit or multi-byte units of data, rather than restricting their scope to individual bits. The techniques for implementing each of the operations within the matrix operations block 140, including those detailed above, are well understood by one of ordinary skill in the art. In some embodiments, one or more matrix operations may be implemented and executed as an atomic operation.

In an embodiment of the invention, matrix multiplication is implemented using high-performance hardware structures such as systolic arrays or linear feedback shift registers (LFSRs) for efficiency and scalability. The scramble operation is implemented with a dedicated memory containing the scramble table bits that are XOR'd bit-by-bit with the data to be encrypted to realize the scramble function (i.e., change appropriate bit values). The permutation operation is implemented with a dedicated memory containing the permutation table of shuffled addresses that are used to read the data to be encrypted in the permuted order. In other embodiments, an LFSR may be used to generate the scramble and permutation tables.

A memory block 122 stores matrix values or “keys” used in linear transformation, arithmetic, and logic operations in addition to scramble/permutation table values used by the scramble/permutation block 146 for data obfuscation. Accordingly, memory block 122 acts as a central storage unit for all the numerical values, keys, and mapping tables that the other hardware blocks need to perform their cryptographic functions efficiently and correctly. By keeping these elements in dedicated, fast-access memory, the MHE-S core 100 ensures that encryption, decryption, and data obfuscation can proceed rapidly and securely, without having to fetch critical values from slower, external storage.

A pseudo-random number generator (PRNG) block 124 implements one or more algorithms to produce matrix values or “keys” used in linear transformation, arithmetic and logic operations in addition to scramble or permutation table values used by the scramble/permutation block 146 for data obfuscation. The design and implementation of the PRNG block 124, as described herein, uses a linear feedback shift register (LFSR).

MUX2 120 selects Matrix “Key” or PRNG Key that will be used for the matrix operations 140 as per the sequencer block 105 based on the needs of the particular matrix operation and the desired balance between security, performance, and resource usage. For scrambling operations, permutation operations, and error correcting code (ECC) encoding, the scramble table values, permutation table values and ECC encoding matrix values use the PRNG 124 or precomputed matrices stored in memory 122.

The matrix operation selector block 135 routes the input data (Unencrypted Data/Encrypted Data′ or Feedback Data) and matrix operands (Matrix “Keys” or RNG/PRNG Keys) to the appropriate matrix operation in the matrix operations block 140 as per the sequencer block 105. MUX3 130 selects the matrix operations result (linear transformation, ALU, scramble/permutation, or a combination thereof) as per the sequencer block 105.

The sequencer block 105 is control logic that orchestrates the entire encryption and decryption process. Its primary function is to manage the flow of data and operations within the core by coordinating other hardware blocks according to a preconfigured schedule. In practical terms, the sequencer block 105 is what ensures that each step, in the cryptographic system chosen, happens in the correct sequence, with the right inputs, outputs, and intermediate results routed to the appropriate processing units at the right time. In an embodiment of the invention, the sequencer block 105 is implemented as a programmable state machine that corresponds to the cryptographic algorithm's requirements. Each clock cycle, the sequencer advances through its sequence, generating the control signals that set the multiplexers, enable the correct matrix operation, and route data through the core 100. For example, with symmetric McEliece encryption, the sequencer 105 is programmed to perform three matrix operations in succession: a scramble, ECC encode and permutation. The scramble table, the ECC matrix values, and permutation tables are stored in memory 122. The scramble table could have been generated by the PRNG 124. For the scramble operation the sequencer 105 sets MUX1 110 to accept the initial Unencrypted Data, sets MUX2 120 to access the scramble table in memory 122, selects, via the matrix operations selector block 135, the scramble function from the scramble/permutation block 146 and the scramble is performed. The sequencer 105 then directs the ALU 144 to calculate the CRC on the scrambled data which will be used for decryption. For the second matrix operation, the ECC encode, the sequencer 105 sets MUX1 110 to select the feedback path, sets MUX2 120 to access the encode matrix values from memory 122 and selects, via the matrix operations selector block 135, the linear transformations block 142 to perform the matrix multiply and accumulate of the feedback data and the matrix values in memory 122. For the third matrix operation, the permutation, the sequencer 105 sets the MUX1 110 to accept feedback data, MUX2 120 to access the permutation table from memory 122 selects, via the matrix operations selector block 135, the permutation function from the scramble/permutation block 146 and the permutation is performed.

The MHE-S micro-architecture core 100 may be implemented in any hardware, including but not limited to any processor chip, memory chip, dedicated MHE-S chip, field programmable gate array (FPGA), or application specific integrated circuit (ASIC). In some embodiments, an MHE-S core in future processors could be tailored to optimize matrix-based security functions to ensure the best combination of performance, energy, obfuscation and die area. In some embodiments, the MHE-S core may be replicated on any chip to enable parallel processing or redundancy. In some embodiments, the MHE-S core may be added to any processor for the hardware accelerated security of data, audio, video, or images. In some embodiments, the MHE-S core may coexist with SPN encryption cores, thus allowing flexibility to use either or both non-SPN and SPN cores.

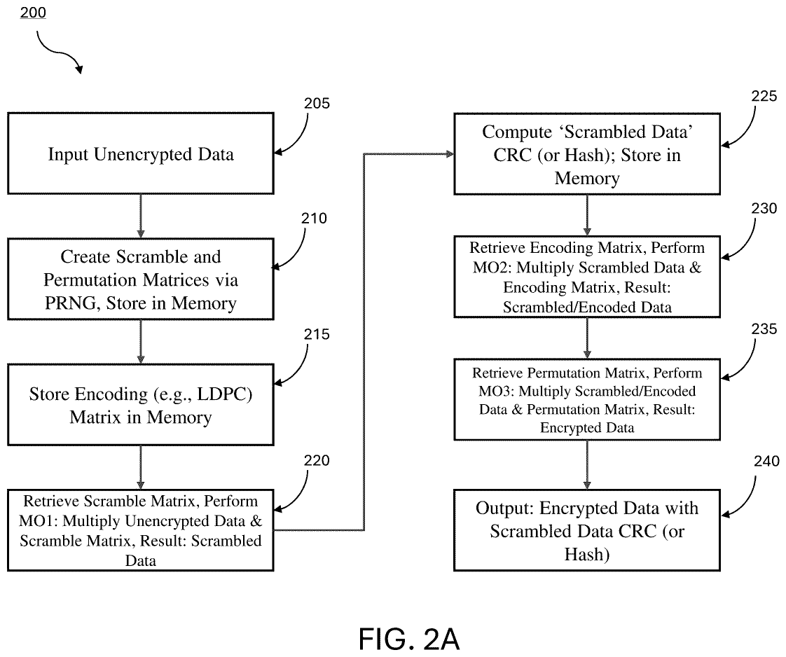

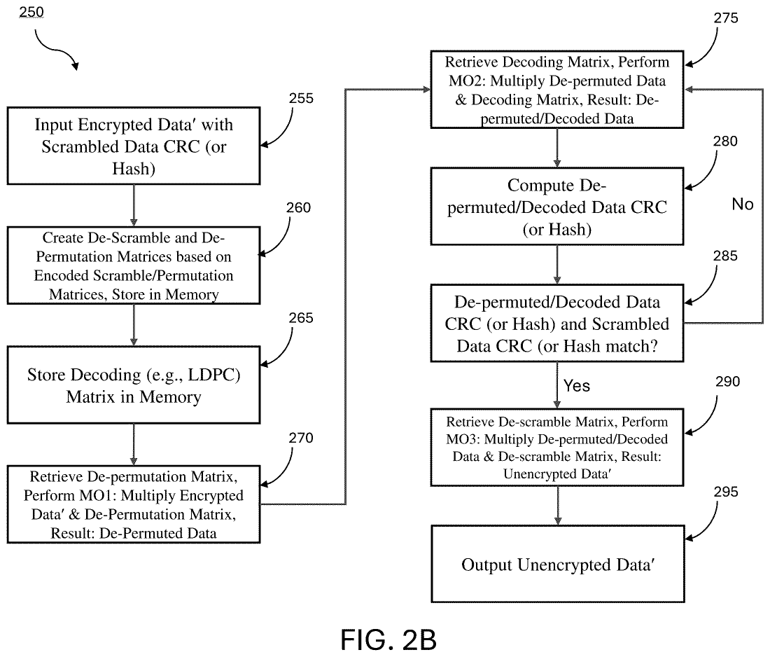

FIG. 2A and FIG. 2B illustrate encryption/encode and decryption/decode flows for symmetric McEliece encryption using the MHE-S core 100 shown in FIG. 1. The encryption/encode flow 200 (FIG. 2A) begins with step 205, where the unencrypted data is input to the system. Step 210 involves creating the scramble and permutation matrices using the PRNG 124 and storing these matrices in memory 122 for subsequent use. In step 215, an encoding matrix, such as a low-density parity-check (LDPC) matrix, is stored in memory 122. Step 220 retrieves the scramble matrix and performs the first matrix operation (MO1), multiplying the input unencrypted data by the scramble matrix to produce scrambled data. Step 225 calculates a cycle redundancy check (CRC) or hash of the “scrambled data,” storing the result in memory 122 for later verification. In step 230, the encoding matrix is retrieved, and the second matrix operation (MO2) is executed, multiplying the scrambled data by the encoding matrix to generate scrambled and encoded data. Step 235 retrieves the permutation matrix and performs the third matrix operation (MO3), multiplying the scrambled and encoded data by the permutation matrix to yield scrambled, encoded, and permuted data, which constitutes the final encrypted data. The system 100 outputs (step 240) the encrypted data along with the previously stored scrambled data CRC or hash. This matrix-based process, using randomization, integrity checks, and linear algebra, delivers robust, flexible, and potentially quantum-resistant encryption, making it directly applicable to McEliece, its variants, and other emerging non-SPN post-quantum ciphers. The hash or the CRC provides a sufficient check that decryption has completed.

The counterpart decryption/decode flow 250 (FIG. 2B) commences with step 255, where Encrypted Data′ accompanied by the scrambled data CRC or hash is input. Then, the encoding matrix operations are performed in reverse order with the counterpart de-permutation, decoding (for example, LDPC codes) and de-scramble matrices. Step 260 generates de-scramble and de-permutation matrices based on the encoded scramble and permutation matrices, storing them in memory 122. In step 265, a decoding matrix (e.g., LDPC matrix) is stored in memory 122. Step 270 retrieves the de-permutation matrix and performs the first matrix operation (MO1), multiplying the input Encrypted Data′ by the de-permutation matrix to produce de-permuted data. In step 275, the decoding matrix is retrieved, and the second matrix operation (MO2) is executed, multiplying the de-permuted data by the decoding matrix to yield de-permuted and decoded data. Step 280 computes a CRC or hash of the de-permuted and decoded data. In step 285, this computed CRC or hash is compared to the scrambled data CRC or hash that accompanied the Encrypted Data′; if they match, the process proceeds to step 290; if not, the process returns to step 275 for another iteration of decoding. In step 290, the de-scramble matrix is retrieved, and the third matrix operation (MO3) is performed, multiplying the de-permuted and decoded data by the de-scramble matrix to produce de-permuted, decoded, and de-scrambled data, which constitutes the final Unencrypted Data′. Step 295 outputs the Unencrypted Data′, ending the decryption/decode flow.

Having detailed the encryption/encode and decryption/decode workflows enabled by the MHE-S micro-architecture core, where unencrypted data is converted to encrypted data and vice versa through a carefully orchestrated series of matrix processing, randomization, and integrity verification steps, it is clear that the MHE-S micro-architecture is both robust and highly adaptable.

The present invention's modular architecture is not only self-contained but also readily scalable: one or more MHE-S cores can be integrated as hardware accelerators into a variety of processor chips, including CPUs, NPUs, GPUs, digital signal processors (DSPs), and other specialized or custom processors. In some embodiments, one or more MHE-S cores may be implemented as a chiplet and used as part of a multi-chip module (MCM) or in a chip stacking configuration using processes such as through silicon vias (TSVs). In some embodiments, the one or more MHE-S cores could be implemented in a standalone chip. This integration enables flexible, high-performance matrix-based cryptographic operations directly at the hardware level, making accelerated, quantum-resistant encryption and decryption widely accessible across both embedded and general-purpose computing platforms.

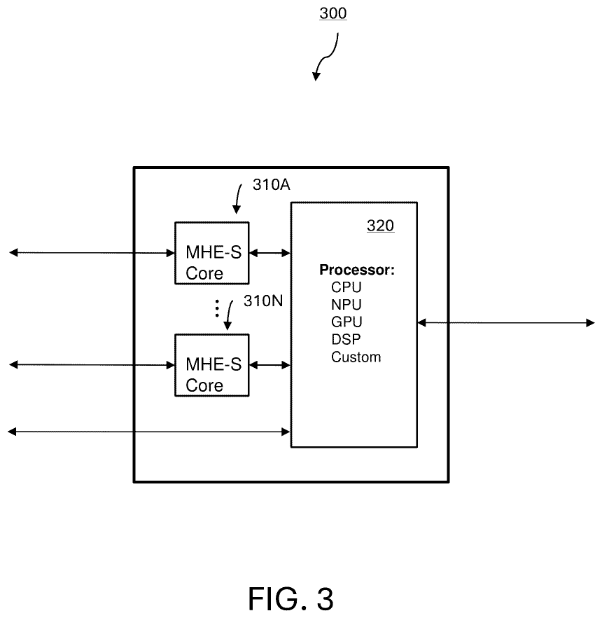

FIG. 3 illustrates a processor 300 with MHE-S cores 310A-N according to an embodiment of the invention. The processor 320 may be of any conventional type, such as a CPU, NPU, GPU, DSP, or may comprise custom logic. Each MHE-S core 310 can be added to a processor chip in a variety of configurations, reflecting the flexibility of the micro-architecture. In some embodiments, the MHE-S cores 310A-N are integrated onto the same die as the processor 320, enabling direct acceleration of matrix-based cryptographic functions within the main processor pipeline. The varied integration options depicted in FIG. 3, each identified by their respective reference numerals, demonstrate the adaptability of the MHE-S micro-architecture to a wide range of semiconductor platforms and packaging technologies, ensuring broad applicability across computing devices and architectures.

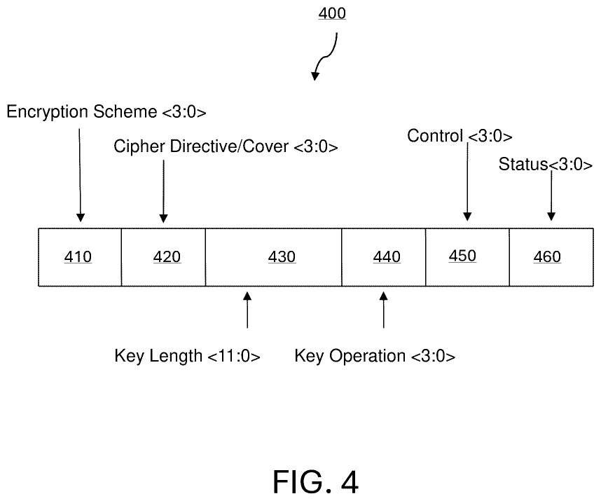

FIG. 4 illustrates an Intelligent Poly Key (IPK) frame structure 400 according to an embodiment of the invention. The IPK frame structure 400 defines two types of fields, cryptographic and control/status. The cryptographic fields are encryption scheme 410, cipher directive 420, key length 430, and key operation 440. The encryption scheme 410 may identify a variety of established ciphers and associated keys. The cipher directive field 420 may identify a variety of custom or emerging ciphers including variants of established ciphers. As an example of a variant of an established cipher, McEliece performs one each of scramble, encode, and permutation operations. A McEliece variant could include more than one of the scramble, encode, and permutation operations. The key length field 430 identifies a variety of key bit lengths that may be used with the ciphers. The key operation 440 field identifies a variety of logical or arithmetic operations that may be performed on key content, in addition to a new key definition. The control field 450 may define system management functions in addition to coupling encryption to specific functions such as forward error correction (FEC), modulation, or AI. The status field 460 reports operational outcomes, such as successful processing, errors, or readiness states of the sender or receiver.

The cryptographic fields enable dynamic, adaptable encryption by allowing successive changes to the encryption process, a feature detailed further in Applicant's U.S. Pat. Nos. 11,054,999, 11,119,670, 11,126,356, 11,334,264, 11,662,924, and 12,061,807, the disclosures of which are incorporated by reference herein. For instance, with McEliece encryption, the IPK frame structure 400 coupled with a dynamic schedule can repeatedly modify any or all of the following: the matrix values, the encoding/decoding matrix type (such as LDPC, Goppa, BCH, or Reed-Solomon), and the asymmetric/symmetric mode of operation. A McEliece variant may further incorporate multiple instances of the scramble, encode, or permutation operations, for example, applying two layers of permutation, two rounds of encoding, or repeated scrambling, in sequence or parallel, to increase the cipher's robustness. These dynamic and modular modifications, including the possibility of layered transforms, significantly increase the computational burden for any attacker attempting to break the encrypted data, while maintaining the flexibility and security advantages of non-SPN, matrix-based cryptography.

In other embodiments, the MHE-S micro-architecture could be modified in a number of ways, including but not limited to the following: vary the block interconnections to streamline operations, combine block functions to optimize performance and efficiency, replicate block functions to parallelize operations to improve performance, remove individual block functions entirely or a subset of a particular block's functions to implement specific non-SPN ciphers that only require a subset of the full complement of the block functions, and leverage existing hardware to implement certain functions and supplement the dedicated hardware functions with software or firmware.

The primary computational engine for accelerating non-SPN ciphers, such as McEliece and related code-based schemes is a hardware block dedicated to matrix multiplication paired with accumulation (referred to as a matrix multiply and accumulate function (MMA), multiply/accumulate, or MAC). One embodiment of the MHE-S micro-architecture uses the linear transformation block 142 to perform the matrix multiply function and the ALU block 144 to perform the accumulate function. MMAs are also at the core of graphics and AI processing. Many companies have embedded, optimized MMAs with varying degrees of parallelism depending on the application. GPUs use MMAs to parallelize tasks in areas such as graphics processing and rendering in addition to AI training. For GPUs, NVIDIA is an industry leader. NPUs use MMAs to accelerate AI and machine learning tasks, with an emphasis on neural network inference and training in more power constrained environments. For NPUs, NVIDIA, Intel, Qualcomm, Apple, and AMD are industry leaders. Some CPUs now include MMAs to enhance the performance of AI and machine learning workloads. For CPUs with MMAs, Intel is an industry leader. The abovementioned GPUs, NPUs and CPUs have intended functions such as graphics, AI, machine learning, deep learning, and neural networks, which are not related to security/obfuscation. In some embodiments, the MHE-S micro-architecture can be realized by leveraging the MMA functions that already exist in these processors. In other embodiments, the MHE-S micro-architecture may be implemented in MMA functions in hardware components not designed for graphics or AI, such as memory controllers, the chips that manage data flow between the processor and memory. Depending on the specific GPU, NPU or CPU capabilities and architecture, the other functions of the MHE-S micro-architecture may be leveraged in hardware when appropriate or implemented in software when necessary. In some embodiments, the MMA hardware could perform the matrix-based non-SPN security without the originally intended graphics or AI functions. In some embodiments, the MMA hardware could perform both the matrix-based non-SPN security and the graphics or AI functions simultaneously. Applicant's U.S. Pat. Nos. 11,054,999, 11,119,670, 11,126,356, 11,334,264, 11,662,924, and 12,061,807 cover instances where security/encryption is coupled to AI functions. The practical result is a flexible micro-architecture that can be optimized for cryptographic processing on existing silicon, with the option to supplement or extend functionality in software or firmware as needed for particular use cases or hardware platforms.

By leveraging these existing MMA capabilities, the MHE-S micro-architecture enables matrix-based non-SPN encryption to run at speeds and efficiencies that would be unattainable in software alone. This approach is especially powerful because it requires no fundamental redesign of the underlying hardware; instead, it adapts the MMA function, already present and heavily optimized for graphics and AI, to perform cryptographic operations. The invention thus offers unprecedented flexibility: the MMA hardware can be allocated entirely to cryptography, used in parallel for both cryptographic and traditional graphics or AI tasks, or dynamically partitioned according to system needs. This ability to repurpose and co-opt widely available computational resources for security represents a significant leap forward in practical, deployable hardware acceleration for next-generation cryptography. Furthermore, the integration with Applicant's patent portfolio, referenced above, illustrates that this repurposing can be extended to support dynamic, session-based encryption changes and even scenarios where security and AI functions are tightly coupled, a further demonstration of the invention's adaptability and forward-looking design. In some embodiments, minor modifications to existing and future processors can optimize the MMA for security.

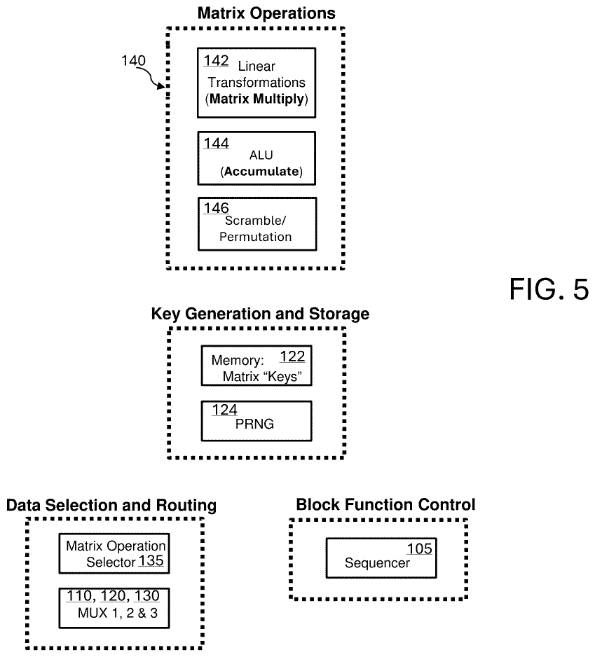

FIG. 5 categorizes the system into matrix operations (142, 144, 146), key generation/storage (122, 124), data selection and routing (110, 120, 130, 130), and block control (105), clarifying both hardware/software/firmware options and system adaptability. The matrix operations category performs linear transformations, ALU, and scramble/permutation functions in hardware. The matrix multiply function is part of the linear transformation block 142 and the accumulate function is part of the ALU block 144. Depending on the specific micro-architecture of the GPUs, NPUs and CPUs, the embedded MMA may be a specific function or part of a block or group of blocks that perform additional linear transformation or arithmetic and logic operations. The matrix-based non-SPN encryption requirements will dictate the additional linear transformation, arithmetic and logic functions that may be leveraged in hardware versus software or firmware. This choice of hardware, software or firmware applies to the scramble/permutation functions, as well. The key generation and storage category contains memory 122 and PRNG 124 functions. Memory 122 will be available on the devices but the connection to the MMA may require assistance from software or firmware. If the devices contain PRNG 124, they can be leveraged when required for encryption; otherwise, external sources of PRNG 124 may be utilized. The data selection and routing category contains the matrix operations selector 135 and multiplexers 110, 120, and 130 (MUX 1, 2, & 3); these functions are micro-architecture specific and will require software or firmware control. The block function control category containing the sequencer functions is also micro-architecture dependent and will require software or firmware control. Whenever the optimal function blocks and interconnections are not implemented in hardware, there is an impact to the encryption performance.

In some embodiments, the MHE-S micro-architecture, as a self-contained entity or implemented with a combination of hardware, software, and firmware, applies to static single point encryption, dynamic single point encryption, and static multi-point encryption. Static single-point encryption is when the aspects of an encryption scheme do not change for a session. Dynamic single point encryption is when one or more aspects of the encryption scheme, including but not limited to cipher, key length, and key content, may successively change during a session. Multi-point encryption uses one or more encryption algorithms that are applied more than one time to data. In some embodiments, MHE-S implementations may employ one or more of the following: static single-point encryption, dynamic single-point encryption, or multi-point encryption. The MHE-S micro-architecture applies to asymmetric and symmetric encryption, key encapsulation, authorization, and authentication. In some embodiments, a processor instruction or a collection of processor instructions may be defined to control the MHE-S micro-architecture encryption algorithm execution in its entirety or in phases.

In summary, the invention enables significant advances in cryptographic performance and efficiency by incorporating a specialized micro-architecture that executes essential matrix-based operations such as matrix multiply-accumulate, linear transformations, logical functions, and scrambling directly within dedicated hardware. This architectural approach eliminates the complexity and latency of traditional, round-based encryption algorithms, empowering the hardware to perform complex, matrix-driven security functions with high speed and energy savings. As a result, encryption and decryption processes become markedly faster and more scalable than those relying on software routines or non-specialized hardware. Furthermore, the invention's ability to operate in parallel with core processing functions including general computation, graphics rendering, and artificial intelligence workloads ensures that robust data protection is delivered without interfering with overall computational demands. By marrying hardware-level acceleration with matrix-based cryptography, the invention provides a practical and resilient solution for meeting the growing requirements of high-performance, secure digital systems in an environment of escalating data volumes and evolving cyber threats.

The embodiments described herein are meant to illustrate the inventive concepts contained herein. Other embodiments and modifications may be made to the compositions and methods without departing from the spirit and scope of the invention. Therefore, the scope of the present invention should not be limited to the embodiments described herein but should be defined by the appended claims and their equivalents.

We claim:

1. A system for matrix-based non-substitution and permutation network (non-SPN) encryption or decryption hardware acceleration comprising:
a matrix operations block configured to perform, in hardware, multiply/accumulate or multiply and addition, as part of matrix-based non-SPN encryption or decryption of data.

2. The system of claim 1, wherein the matrix operations block comprises a linear transformations block configured to perform a linear transformation selected from the group consisting of: multiply, multiply/accumulate, addition, change of basis, inner (dot) product, quantization, scaling, rotations, shearing, and a combination thereof.

3. The system of claim 1, wherein the matrix operations block comprises an arithmetic and logic unit (ALU) block configured to perform an operation selected from the group consisting of: Boolean operation, addition, bit or byte manipulation, and a combination thereof.

4. The system of claim 1, wherein the matrix operations block is also configured to perform, in hardware, multiply/accumulate or multiply and addition, as part of graphics processing or artificial intelligence processing.

5. The system of claim 1, wherein the matrix operations block comprises a scramble/permutation block configured to perform bit, multi-bit, or muti-byte changes defined by a scramble table and/or perform bit, multi-bit, or muti-byte shuffling as defined by a permutation table.

6. The system of claim 1, further comprising a memory block storing data selected from the group consisting of: one or more keys used in the matrix-based non-SPN encryption or decryption of data, one or more scramble tables, one or more permutation tables, and a combination thereof.

7. The system of claim 1, further comprising a pseudo-random number generator block to generate one or more keys used in the matrix-based non-SPN encryption or decryption of data.

8. The system of claim 1, further comprising a sequencer block configured to control data flow and an order of matrix operations.

9. The system of claim 1, wherein the matrix-based non-SPN encryption or decryption of data is based on a McEliece cryptosystem, and the matrix operations block is configured to perform at least one each of matrix operations: a scramble, an error correction code (ECC) encode, and a permutation.

10. The system of claim 1, wherein the matrix operations block is implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller.

11. The system of claim 1, wherein the matrix operations block is assisted by one or more processor instructions.

12. The system of claim 1, wherein the matrix-based non-SPN encryption or decryption of data comprises asymmetric encryption, symmetric encryption, or key encapsulation.

13. The system of claim 1, wherein the matrix-based non-SPN encryption or decryption of data enables authorization or authentication.

14. A method for matrix-based non-substitution and permutation network (non-SPN) encryption or decryption hardware acceleration, comprising:
performing, within a matrix operations block, multiply/accumulate or multiply and addition in hardware, as part of matrix-based non-SPN encryption or decryption of data; and
outputting encrypted or decrypted data.

15. The method of claim 14, wherein the matrix operations block comprises a linear transformations block, and performing, within the linear transformations block, a linear transformation selected from the group consisting of: multiply, multiply/accumulate, addition, change of basis, inner (dot) product, quantization, scaling, rotations, shearing, and a combination thereof.

16. The method of claim 14, wherein the matrix operations block comprises an arithmetic and logic unit (ALU) block, and performing, within the ALU block, an operation selected from the group consisting of: Boolean operation, addition, bit or byte manipulation, and a combination thereof.

17. The method of claim 14, further comprising performing, within the matrix operations block, multiply/accumulate or multiply and addition in hardware, as part of graphics processing or artificial intelligence processing.

18. The method of claim 14, wherein the matrix operations block comprises a scramble/permutation block, and performing, within the scramble/permutation block, bit, multi-bit, or muti-byte changes defined by a scramble table, and/or bit, multi-bit, or muti-byte shuffling as defined by a permutation table.

19. The method of claim 14, further comprising storing, in a memory block, data selected from the group consisting of: one or more keys used in the matrix-based non-SPN encryption or decryption of data, one or more scramble tables, one or more permutation tables, and a combination thereof.

20. The method of claim 14, further comprising generating, using a pseudo-random generator block, one or more keys used in the matrix-based non-SPN encryption or decryption of data.

21. The method of claim 14, further comprising controlling, using a sequencer block, data flow and an order of matrix operations.

22. The method of claim 14, wherein the matrix-based non-SPN encryption or decryption of data is based on a McEliece cryptosystem, and performing, within the matrix operations block, at least one each of matrix operations: a scramble, an error correction code (ECC) encode, and a permutation.

23. The method of claim 14, wherein the matrix operations block is implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller.

24. The method of claim 14, further comprising processing one or more processor instructions as part of the matrix-based non-SPN encryption or decryption of data.

25. The method of claim 14, wherein the matrix-based non-SPN encryption or decryption of data comprises asymmetric encryption, symmetric encryption, or key encapsulation.

26. The method of claim 14, wherein the matrix-based non-SPN encryption or decryption of data enables authorization or authentication.
